(19) United States
(12) Patent Application Publication
(10) Pub. No.: US 2010/0200360 A1
(43) Pub. Date: Aug. 12, 2010

(54) CAPACITY-LIMITED WASTE RECEIVING DEVICE FOR WASTE COLLECTION SYSTEM

(75) Inventors: Seung-Hyun KANG, Yongin-si (KR); Jong-Kyu HWANG, Anyang-si (KR); Yun-Ho JUNG, Suwon-si (KR); Sang-Bong CHANG, Seoul (KR)

Correspondence Address: LAW OFFICES OF ALBERT WAI-KIT CHAN, PLLC, 141-07 20TH AVENUE, WORLD PLAZA, SUITE 604, WHITESTONE, NY, 11357, US

(73) Assignees: KOLON CONSTRUCTION CO., LTD., Gwachun-si (KR); EUNSUNG PLANT CO., LTD., Siheung-si (KR)

(21) Appl. No.: 12/562,586

(22) Filed: Sep. 18, 2009

(30) Foreign Application Priority Data
Feb. 6, 2009 (KR) 10-2009-0009636

(51) Int. Cl. B65G 11/20; B65G 11/02; B65G 11/00

(52) U.S. Cl. 193/32

(57) ABSTRACT

There is provided a capacity-limited waste receiving device for a waste collection system, in which a waste receiving device in a vacuum-conveyance waste collection system (which conveys waste along a line) automatically conveying the waste to a central collecting station is improved to be more efficient. The capacity-limited waste receiving device for a waste collection system in which the waste being put into a waste receiving device is automatically conveyed to a central collecting station through a conveying line, comprises: a cover to be opened/closed to open/close the waste receiving device; and a housing with an upper end and a lower end, the upper end on which the cover is installed and the lower end which is connected to the conveying line connected to the central collect storage, wherein the housing comprises: an inlet passage casing with an upper end to which the cover is attached; an under passage casing installed under the inlet passage casing; a damper installed between the inlet passage casing and the under passage casing; a chute connected to a lower end of the under passage casing, wherein a discharge valve for discharging the waste to the conveying pipe is installed under the chute; and an interlocker operatively connecting the cover and the damper, ensuring that either opening or closing of the cover is opposite to either opening or closing the damper.

### CROSS-REFERENCE TO RELATED APPLICATION

This application claims the benefit of Korean Patent Application No. 2009-0009636, filed Feb. 6, 2009, the disclosure of which is hereby incorporated herein by reference in its entirety.

### BACKGROUND OF THE INVENTION

1. Field of the Invention

The present invention relates to a capacity-limited waste receiving device for a waste collection system, and more particularly, to a capacity-limited waste receiving device for a waste collection system, in which a conventional waste receiving device in a vacuum-conveyance waste collection system (which is conveys waste along a line) automatically conveying waste to a central collecting station is improved and more efficient.

2. Description of the Related Art

According to a conventional method of collecting waste generated by each household living in condominiums, apartments and public houses, when people drop off the waste at a certain place, a waste collection vehicle picks up the waste. However, in the conventional method, since the waste is abandoned in a waste collecting place installed in a multi-unit building area for a certain period, it is unpleasant to see, it smells bad especially in the summer time and it becomes a habitat and hiding place for flies and mosquitoes.

Therefore, an automatic system for collecting waste has been introduced. When waste is put into a waste receiving device positioned at a certain place, the waste is conveyed to and collected at a central waste collecting station through a conveying line buried underground, based on the control of a computer automatic control system.

According to the system of automatically collecting waste, each fixed collecting facility automatically conveys the waste to a central collecting station. The waste received through a waste receiving device is temporarily stored in a chute under which a discharge valve is installed, and when an air blower installed within the central collecting station is operated, an air inlet is opened so that air is drawn into the conveying line buried underground. Then, when a strong air flow is formed in the conveying line, the discharge valve positioned under the chute is open and the waste stored within the chute moves down into the conveying line buried underground by gravity and air suction power, to be conveyed to the central collecting station, together with the high-speed air. In this system, when waste is put into the waste receiving device, the waste is automatically conveyed. Therefore, since the waste does not need to accumulate at a certain place, the surrounding environment is pleasant and nice in appearance and mice, cats and noxious insects are absent, thereby forming a clean residential environment.

However, in the aforementioned system, a user opens a cover to open a conventional waste receiving device. Therefore, when the user holds a heavy garbage bag or holds garbage bags in both hands, it is inconvenient to use the system. Moreover, the conventional waste receiving device does not limit various oversized waste (such as bulky waste, a long rod or the like) from being received into the waste collection system. Therefore, when the waste receiving device or the discharge valve is blocked, the operation of the system has to be stopped and the device or discharge valve needs to be fixed. Furthermore, since the waste cannot be put into the waste receiving device until the device or the discharge valve is fixed, this system would frequently have more problems than the method of collecting the waste by garbage collectors.

### SUMMARY OF THE INVENTION

Therefore, it is an aspect of the present invention to provide a capacity-limited waste receiving device for a waste collection system which is improved and more efficient than a waste receiving device in a vacuum-conveyance waste collection system (which conveys waste along a line), making it easier for a user to put waste into an opening and preventing any oversized waste from being put into the opening.

The above and other aspects of the present invention are substantially realized by providing a capacity-limited waste receiving device for a waste collection system, comprising: a cover to open/close the waste receiving device; and a housing having an upper end and a lower end, the upper end on which the cover is positioned and the lower end which is connected to a conveying line connected to a central collecting station, wherein the housing comprises: an inlet passage casing positioned at its upper position and on which the cover is attached; an under passage casing installed under the inlet passage casing; a damper installed between the inlet passage casing and the under passage casing; a chute connected under the under passage casing, wherein a discharge valve for discharging waste to a conveying line is installed under the chute; and an interlocker for operatively connecting the cover and the damper and ensuring that either the opening or closing of the cover is opposite to either the opening or closing of the damper.

Preferably, the interlocker controlling the operation of the cover and damper comprises: a damper shaft fixedly connected to the damper in a single body; a shaft connection unit connected to one end of the damper shaft; a first link bar connected to the other end of the damper shaft; a second link bar connected to the cover and opening/closing the cover; and a link tension bar connecting the first and second link bars.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a perspective view illustrating a capacity-limited waste receiving device with an opening open when a cover is opened in a waste collection system according to the present invention;

FIG. 2 is a right sectional view illustrating the inside of the capacity-limited waste receiving device installed on and under the ground;

FIG. 3 is a left section view illustrating the inside of the capacity-limited waste receiving device installed on the ground; and

FIG. 4 is a perspective view illustrating the capacity-limited waste receiving device in which the cover is closed and a damper is opened by an interlocker.

### DESCRIPTION OF REFERENCE NUMBERS OF MAJOR ELEMENTS

| | |
|---|---|
| 10: cover | 101: round bar |
| 20: housing | 21: inlet passage casing |
| 211: inlet guide | 22: under passage casing |
| 23: chute | 24: damper |
| 25: discharge valve | 26: interlocker |
| 261: shaft connection unit | 262: damper shaft |
| 263: first link bar | 264: second link bar |
| 265: link tension bar | 266: gas spring |
| 267: air cylinder | 27: louver |
| 30: conveying-line | 31: air pipe |
| 50: link cover | |

### DETAILED DESCRIPTION OF THE PREFERRED EMBODIMENT

The present invention will now be described more fully hereinafter with reference to the accompanying drawings, in which preferred embodiments of the invention are shown. However, it is to be understood that the scope of the invention is not limited to the disclosed embodiments.

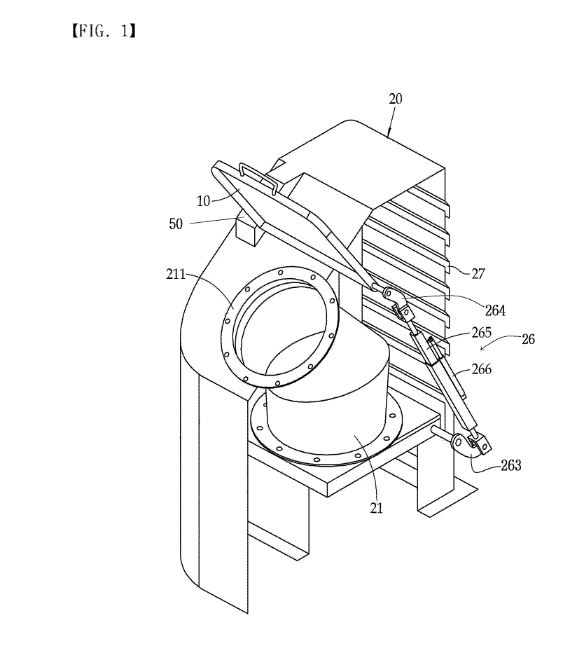

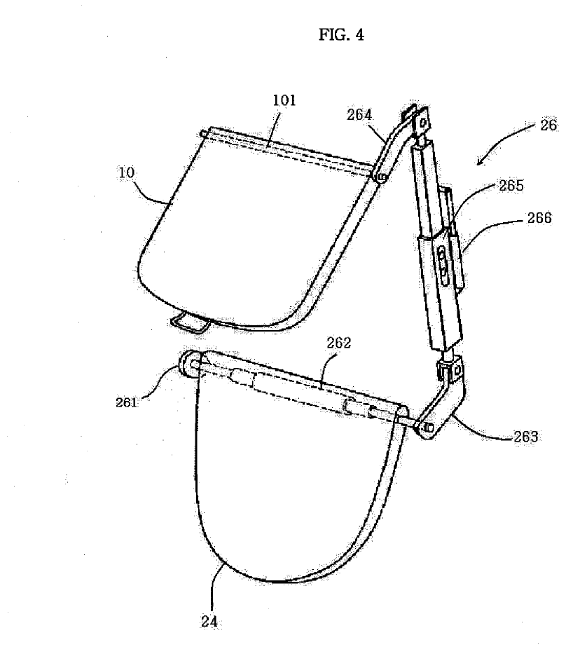

With reference to FIGS. 1 to 4, a capacity-limited waste receiving device according to an embodiment of the present invention will be described. The capacity-limited waste receiving device is applied to a waste collection system in which the waste received through the waste receiving device is automatically conveyed to a central collecting station through a conveying line.

FIG. 1 is a perspective view illustrating the capacity-limited waste receiving device for the waste collection system according to the present invention, in which a cover is open. As illustrated in FIG. 1, the capacity-limited waste receiving device comprises: a cover 10 to be opened/closed to open/close the waste receiving device; and a housing 20 with an upper end and a lower end, the upper end on which the cover 10 is installed and the lower end which it is connected to a conveying line 30 connected to the central collecting station. The housing 20 comprises: an inlet passage casing 21, an under passage casing 22, a damper 24; a chute 23; and an interlocker 26. The inlet passage casing 21 has an upper end to which the cover 10 is attached. The under passage casing 22 is installed under the inlet passage casing 21. The damper 24 is installed between the inlet passage casing 21 and the under passage casing 22. The chute 23 is connected to an lower end of the under passage casing 22, and a discharge valve 25 for discharging waste to the conveying line 30 is installed under the chute 23. The interlocker 26 operatively connects the cover 10 and the damper 24, ensuring that either the opening or closing of the cover 10 is opposite to either the opening or closing of the damper 24.

The interlocker 26 comprises: a damper shaft 262, a shaft connection unit 261; a first link bar 263; a second link bar 264; and a link tension bar 265. The damper shaft 262 is fixedly connected to the damper 24 in a single body. The shaft connection unit 261 is connected to one end of the damper shaft 262.

The first link bar 263 is connected to the other end of the damper shaft 262. The second link bar 264 is connected to the cover 10, to open/close the cover 10. The link tension bar 265 connects the first link bar 263 and the second link bar 264, ensuring that either the opening or the closing of the cover 10 is opposite to either the opening or closing of the damper 24. In other words, when the cover 10 is open the interlocker 26 ensures that the damper 24 is closed. In like manner, when the cover 10 is closed, the interlocker 26 ensures that the damper 24 is open.

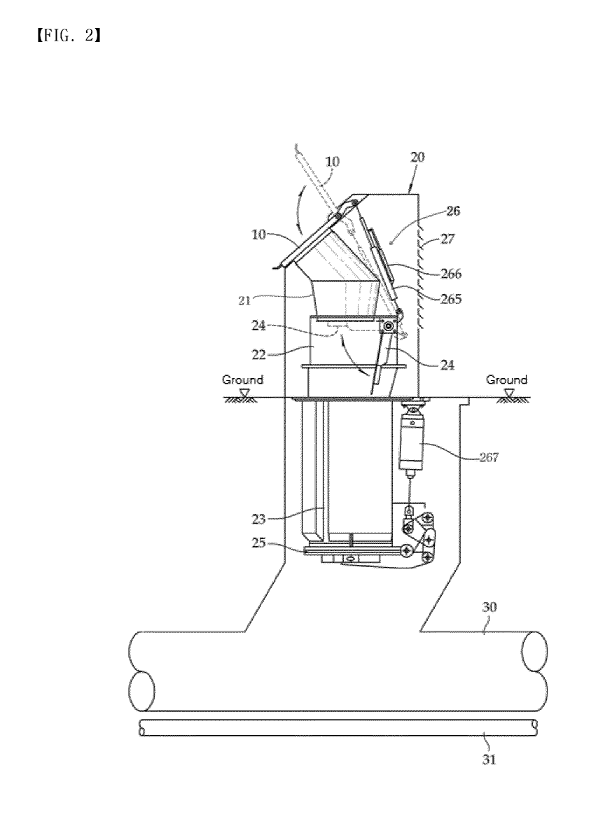

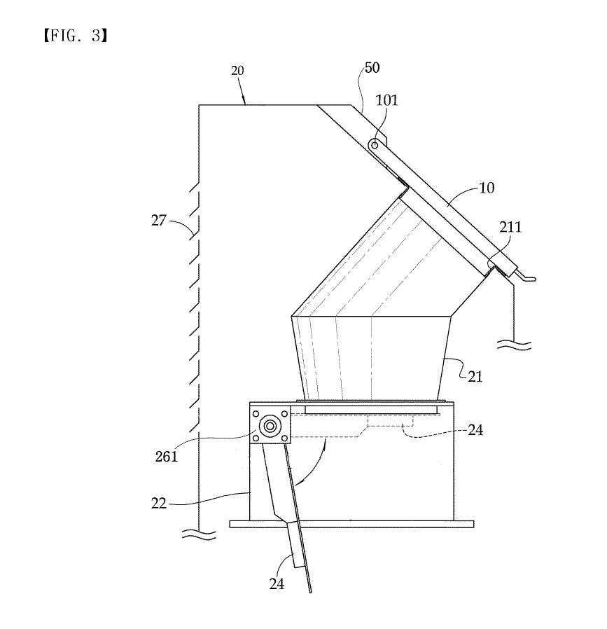

As illustrated in FIGS. 2 and 3, a louver 27 is installed at a back side of to the housing 10. The louver 27 draws external air in. When the discharge valve 25 is open, the louver 27 supplies the drawn air to the chute 23, so that the waste stored in the chute 23 is easily discharged to the conveying line 30. The louver 27 may be installed by using a coupling unit (screw or the like), to be separable from the housing 20 when the inside of the waste receiving device needs to be checked.

An inlet guide 211 is further installed on the inlet passage casing 21 by maintaining a vacant space at a certain distance from the inlet passage casing 21. This vacant space is to form a passage through which the air flows into the inlet passage casing 21 from outside the inlet passage casing 21. A handle is securely connected to one side of the cover 10. The handle protrudes at a higher position than a lower end of the cover 10 so as to be inclined upward at an angle. An air-filled packing is installed inside a lower side of the cover 10, maintaining airtightness inside the waste receiving device and having an absorbing function to lessen noise and shock when the cover 10 is closed.

Link covers 50 are each installed at both sides on the housing 20. A round bar 101 is supported at a side of the link cover 50. The round bar 101 rotates around the central axis. The round bar 101 and the cover 10 are fixedly connected together in a single body. Further, the second link bar 264 is fixedly connected to one side of the round bar 101 in a single body. The cover 10 fixedly connected to the round bar 101 in the single body pivots vertically around the central axis of the round bar 101, so that the cover 10 installed above the inlet passage casing 21 of the waste receiving device is opened/closed.

The damper shaft 262 is installed at one side of an upper part of the under passage casing 22. The damper shaft 262 rotates around its central axis. The damper shaft 262 is fixedly connected to the damper 24 in a single body. One end of the damper shaft 262 is fixedly connected to the first air cylinder 261 by a cylinder arm 267. The other end of the damper shaft 262 is fixedly connected to the first link bar 263. The damper 24 fixedly connected to the damper shaft 262 in the single body pivots up and down around the central axis of the damper shaft 262, thereby opening/closing a lower opening of the inlet passage casing 21 of the waste receiving device.

The damper shaft 262 is connected to the shaft connection unit 261 so as to rotate. The damper shaft 262 is rotated by the operation of the first link bar 263 connected to its other end, to open/close the damper 24.

The shaft connection unit 261 is installed at one side of the under passage casing 22, so as to be opposite to the first link bar 263. The shaft connection unit 261 supports the damper shaft 262.

The damper 24 in a hinge type is installed at a lower end of the inlet passage casing 21, i.e., an upper end of the under passage casing 22, to be opened/closed. The damper 24 is operatively connected to the cover 10 installed on the inlet passage casing 21 so that either the opening or closing of the damper 24 is opposite to either the opening or closing of the cover 10 by the interlocker 26. That is, when the cover 10 on the inlet passage casing 21 is opened, the damper 24 under the inlet passage casing 21 is closed, and when the cover 10 on the inlet passage casing 21 is closed, the damper 24 under the inlet passage casing 21 is opened.

The interlocker 26 operatively connecting the cover 10 and the damper 24 comprises: the first link bar 263; the link tension bar 265; a gas spring 266, the second link bar 264, the damper shaft 262 and the shaft connection unit 261. As illustrated in FIGS. 1 through 4, in the structure of opening the cover 10 in the capacity-limited waste receiving device, the first link bar 263 tightly and tensionally pulls the second link bar 264 fixedly connected to the cover 10 in the single body, by the link tension bar 265. In the structure of closing the cover 10, a length of the link tension bar 265 connecting the first link bar 263 and the second link bar 264 fixedly connected to the cover in the single body may be varied.

The link tension bar 265 connected to one end of the first link bar 263 and one end of the second link bar 264 includes a slot inside so as to be variable in length. The length of the link tension bar 265 is variable as long as a length of the slot. The gas spring 266 connected to the link tension bar 265 performs an absorbing function to a change in the length of the link tension bar 265. When the user opens/closes the cover 10, the user's hand is caught under the cover 10 from carelessness, the gas spring 266 safely stops the cover 10. When the cover 10 on the inlet passage casing 21 having a capacity-limited space is open, the damper 24 installed under the inlet passage casing 21 closes the bottom of the inlet passage casing 21 to be closed, thereby preventing oversized waste, long rods or the like from being received into the under passage casing 22 when the cover 10 is opened. When the cover 10 installed on the inlet passage casing 21 is closed, the damper 24 installed under the inlet passage casing 21 opens the bottom of the inlet passage casing 21 to be opened so that the waste temporarily stored in the inlet passage casing 21 drops into the under passage casing 22 installed to be connected to the lower end of the inlet passage casing 21 and freely passes through the under passage casing 22 from the inlet passage casing 21.

The waste passing through the inside of the under passage casing 22 is temporarily stored in the chute 23 installed to be connected to the lower end of the under passage casing 22. When the discharge valve 25 installed under the chute 23 is opened, the waste is conveyed to the central waste collecting station through the conveying line 30 connected under the chute 23. The operation of the discharge valve 25 is controlled by an air cylinder 267. The waste conveying pipe 30 and an air pipe 31 are connected to the central collecting station of the waste collection system (system for conveying waste through a line).

The end of the damper 24 is formed to be rounded in a U shape, so that the waste can be smoothly discharged without being stuck in the damper 24 when the damper 24 is opened to discharge the waste into the under passage casing 22.

The cover 10 and the damper 24 are operatively connected by the interlocker 26 so that the opening/closing of the cover 10 and damper 24 are controlled. When the user opens the cover 10 to put waste into the waste receiving device, the round bar 101 fixedly connected to the cover 10 in the single body rotates clockwise and the second link bar 264 with its one end fixedly connected to the round bar 101 also rotates clockwise, together with the round bar 101. Then, the link tension bar 265 connected to the other end of the to second link bar 264 moves down and the cover 10 is opened. When the first link bar 263 connected to the lower end of the link tension bar 265 rotates clockwise, the damper shaft 262 fixedly connected to one end of the first link bar 263 in the single body also rotates clockwise, so that the damper 24 fixedly connected to the damper shaft 262 in the single body is closed.

Further, when the damper 24 is closed after waste is put into the waste receiving device, the operation is performed in the opposite manner such that the damper 24 is open to drop the waste into the under passage casing 22. Either the opening or the closing of the cover 10 is opposite to either the opening or closing of the damper 24 by the operation of the interlocker 26.

As described above, in the capacity-limited waste receiving device for the waste collection system (system for conveying waste by a line) according to the present invention, the cover and the damper, respectively installed on and under the inlet passage casing formed of a capacity-limited space, are operatively connected to prevent oversized waste (i.e., waste being larger than a certain size, a rod being longer than a certain length, or the like) from being put into the waste receiving device. Accordingly, the capacity-limited waste receiving device prevents the waste collection system from malfunctioning due to the oversized waste being placed into the collection system.

Furthermore, it prevents any labor or physical loss caused when the waste receiving device and the discharge valve are blocked by the oversized waste.

The invention has been described using preferred exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

1. A capacity-limited waste receiving device for a waste collection system in which the waste being put into the waste receiving device is automatically conveyed to a central collecting station through a conveying line, comprising:
a cover to be opened/closed to open/close the waste receiving device; and
a housing with a upper end and a lower end, the upper end on which the cover is installed and the lower end which is connected to the conveying line connected to the central collect storage, wherein the housing comprises:
an inlet passage casing with an upper end to which the cover is attached;
an under passage casing installed under the inlet passage casing;
a damper installed between the inlet passage casing and the under passage casing;
a chute connected to a lower end of the under passage casing, wherein a discharge valve for discharging the waste to the conveying pipe is installed under the chute; and
an interlocker operatively connecting the cover and the damper, ensuring that either opening or closing of the cover is opposite to either opening or closing the damper.

2. The capacity-limited waste receiving device according to claim 1, further comprising: a louver installed on a back side of the housing, to check the waste receiving device and to draw air in.

3. The capacity-limited waste receiving device according to claim 1, wherein the interlocker comprises:
a damper shaft fixedly connected to the damper in a single body;
a shaft connection unit connected to one end of the damper shaft;
a first link bar connected to the other end of the damper shaft;
a second link bar connected to the cover, for opening/closing the cover; and
a link tension bar for connecting the first link bar and the second link bar.

4. The capacity-limited waste receiving device according to claim 3, wherein the link tension bar comprises a slot formed inside, so that a length of the link tension bar is variable.

5. The capacity-limited waste receiving device according to claim 3, wherein the link tension bar further comprises a gas spring for performing an absorbing function to a change in the length of the link tension bar.
